(19) United States
(12) Patent Application Publication
(10) Pub. No.: US 2014/0020295 A1
(43) Pub. Date: Jan. 23, 2014

(54) ARCHITECTURAL CLOSURE POWERING DEVICE

(71) Applicant: STANLEY SECURITY SOLUTIONS, INC., Indianapolis, IN (US)

(72) Inventors: Bryan J. Bonahoom, Fishers, IN (US); Rodrigue Nyamaswa, Indianapolis, IN (US)

(73) Assignee: STANLEY SECURITY SOLUTIONS, INC., Indianapolis, IN (US)

(21) Appl. No.: 13/868,537

(22) Filed: Apr. 23, 2013

Related U.S. Application Data
(60) Provisional application No. 61/636,893, filed on Apr. 23, 2012.

(51) Int. Cl. E05F 15/20; H01F 38/14; G01B 7/14

(52) U.S. Cl. CPC E05F 15/2076; G01B 7/14; H01F 38/14
USPC 49/25; 324/654; 307/104

(57) ABSTRACT

A closure lock has a wireless power coupling. The wireless power coupling is used to determine whether the closure is in an open or closed position.

### CROSS-REFERENCE TO RELATED APPLICATIONS

This application claims the benefit of U.S. Provisional Patent Application No. 61/636,893, titled “Architectural Closure Powering Device,” filed Apr. 23, 2012, the entire disclosure of which is expressly incorporated by reference herein.

### FIELD

The present invention relates to architectural closures, such as doors and windows. More particularly, the present device relates to electronic architectural closure devices, such as electric locks, door closers, and other electrical devices related to architectural closures.

### BACKGROUND AND SUMMARY

The ability to open and close architectural closures, such as doors and windows, is often controlled to prevent unauthorized entry into buildings or rooms or to aid in opening and closing the closure. The position of architectural closures may also be monitored to determine if the closure has been opened.

According to an exemplary embodiment of the present disclosure, a closure position detector is provided for use with an architectural opening having a perimeter and a closure having an outer perimeter and moveable between an open position and a closed position closing the opening. The closure position detector includes an electronic device supportable by the closure and including a wireless power coupling configured to receive power wirelessly through the perimeter of the closure to power the electronic device, and a closure position monitor monitoring the wireless power coupling to determine the position of the closure.

According to another exemplary embodiment of the present disclosure, an architectural opening and closure system is provided. The system includes an architectural opening having a perimeter, a closure having an outer perimeter and moveable between an open position and a closed position closing the architectural opening. The system further includes a closure position detector, an electronic device supported by the closure and including a wireless power coupling configured to receive power wirelessly through the perimeter of the architectural opening to power the electronic device and a closure position monitor monitoring the wireless power coupling to determine the position of the closure.

According to another exemplary embodiment of the present disclosure, an electronic closure device is provided for use with an architectural opening having a perimeter and a closure having an outer perimeter and moveable between an open position and a closed position closing the opening. The electronic closure device is supportable by the closure and includes a wireless power coupling configured to receive power wirelessly through the perimeter of the closure to power the electronic closure device and a controller receiving input from the wireless power coupling providing power. The controller anticipates the format of the input and provides a predetermined output based on the format of the input.

According to yet another exemplary embodiment of the present disclosure, an electronic closure device is provided for use with an architectural opening having a perimeter and a closure having an outer perimeter and moveable between an open position and a closed position closing the opening. The electronic closure device is supportable by the closure and includes a wireless power coupling configured to receive power wirelessly through the outer perimeter of the closure and a controller operative to control an operation of the electronic closure device. The electronic closure device further includes an ultracapacitor configured to store the power received by the wireless power coupling for powering the electronic closure device.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is diagrammatic view of a structure having a plurality of architectural openings provided by devices, such as windows and doors, the view shows a window with a window opener, a door with an electric mortise lock (shown in phantom), a door with an electric door closure, and an electric door egress device, each powered by a wireless power coupling; and

FIG. 2 is a diagrammatic view of a door frame and a door showing a portion of an inductive coupler positioned in the door frame transmitting power to another portion of the inductive coupler positioned in the door to power a mortise lock positioned in the door.

### DETAILED DESCRIPTION OF THE DRAWINGS

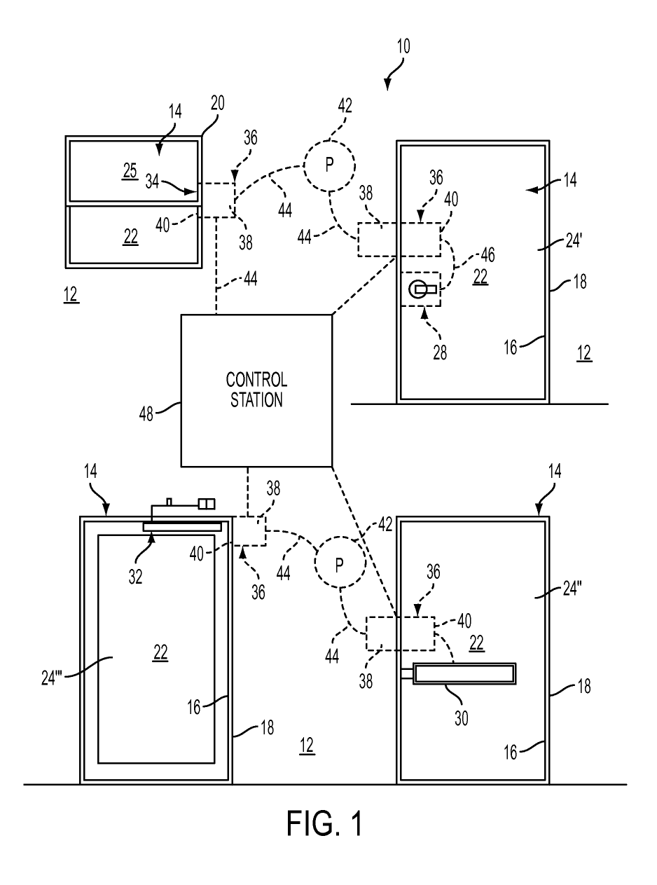

Referring to FIG. 1, a building or other architectural structure 10 is shown and includes walls 12 and a plurality of architectural openings 14 providing access through walls 12. Architectural openings 14 include perimeters 16, such as door and window frames, that permit passage therethrough. For example, door frame 18 is a perimeter that permits passage of people and objects therethrough and window frame 20 permits the passage of air therethrough. To control access through openings 14, closures 22 are provided that move between an open position permitting passage through openings 14 and a closed position blocking passage through openings 14. For example, an architectural opening and closure system for a doorway may include door frame 18 and a closure in the form of door 24 that moves between an open position and a closed position. As a further example, an architectural opening and closure system for a window may include window frame 20 and a closure in the form of a window 25 that moves between an open position and a closed position.

According to the present disclosure, the systems may include electronic devices 26 that are supported by closures 22. For example, door 24′ supports an electronic lock 28 that blocks door 24′ from being opened. Door 24″ supports an electronic exit device 30 that also blocks movement of door 24″. Door 24′″ supports an automatic electronic door opener 32 that assists opening of door 24″′. Further, window 25 may support an automatic electronic window opener 34 that assists opening of window 25. Each of these electronic devices 26 require electric power to operate. For example, these devices may include a motor or solenoid operated with electric power. Other examples of electronic devices 26 supported by closures may include keypads, card readers, closure status (i.e. open or closed) indicators, etc. Window 25 may support a transparent, electronic thin film that displays information, such as the time of day. Suitable electronic locks are disclosed in U.S. Pat. No. 6,720,861 to Rodenbeck et al., U.S. Pat. Nos. 5,931,430 to Palmer, and 5,421,178 to Hamel et al.; a suitable electronic exit device is disclosed is U.S. Provisional Patent Application No. 61/333.430 to Hickman et al; and a suitable door opener is disclosed in U.S. Pat. No. 5,881,497 to Borganrd; the disclosures of which are expressly incorporated by reference herein.

According to the present disclosure, these electronic devices 26 include power couplings 36 that transmit power through perimeters 16 of architectural openings 14. Typically, each coupling 36 includes a perimeter portion 38 supported by perimeter 16 of openings 14 and a closure portion 40 supported by each closure 22. Perimeter portion 38 is electrically coupled to a power supply 42 through electrical conduit 44, such as wire. Perimeter portion 38 transmits power across the joint or gap between perimeters 16 and closures 22 to closure portion 40. Closure portion 40 is electrically coupled to other components of electronic devices 26 through electrical conduit 46, such as wire or circuitry.

According to the preferred embodiment of the present disclosure, power couplings 36 transmit power from perimeter portion 38 to closure portion 40 wirelessly. For example, according to the preferred embodiment, power couplings 36 are inductive couplings including, for example, inductive wire coils. Perimeter portion 38 generates an alternating electromagnetic (EM) field, which generates electrical currents in closure portion 40. This electrical current is used to provide electrical power for electronic devices 26.

According to the preferred embodiment of the present disclosure, in addition to providing wireless power transmission, power couplings 36 detect the position of closures 22. For example, when closures 22 are open, perimeter portions 38 and closure portions 40 of power couplings 36 are spaced further apart than when closures 22 are closed. When further apart, the power transmission between perimeter portions 38 and closure portions 40 becomes less efficient to the point of being non-existent. If electronic devices 26 (or a central monitoring station 48) detect that power is no longer being transmitted by power couplings 36, or that the power transmitted is reduced, this may indicate that closures 22 have moved to an open position. Electronic devices 26 (or central monitoring station 48) may then use this information for access control. For example, if one of doors 24 is forced open by an unauthorized person, electronic device 26 or central monitoring station 48 may set off an alarm. If doors 24 remain open for too long after being opened by an authorized user, it may indicate that door 24 is being propped open and an alarm may sound. Depending on the degree or magnitude of power transfer, electronic device 26 or control station 48 can determine how far a closure 22 is open. For example, a lesser degree of power transfer may indicate a larger opening of closure 22.

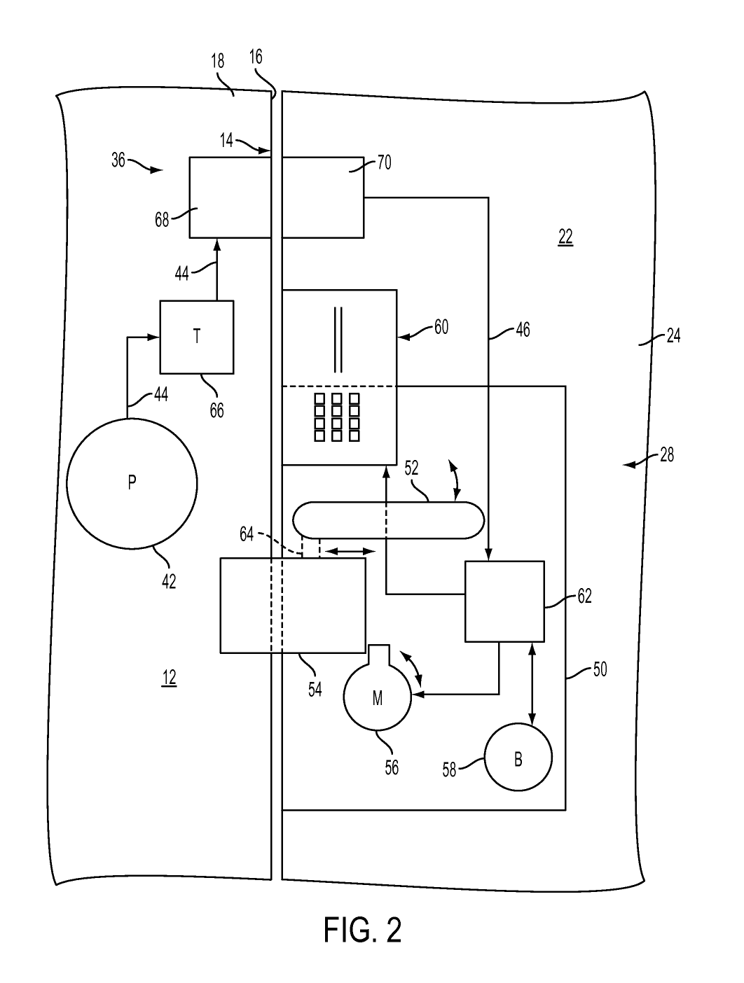

Additional details of door lock 28 are provided in FIG. 2. Door lock 28 includes a housing or chassis 50, a handle 52, a latch bolt 54 that extends between door 24 and door frame 18, an electric motor 56 that moves between a first position blocking retraction of latch bolt 54 and a second position permitting refraction of latch bolt 54 by handle 52, an energy storage device 58 that stores electrical power received from power coupling 36, an input device, such as a keypad, card reader, etc., 60 that receives credentials, and a controller 62 that controls operation of lock 28. Lock 28 further includes a linkage or other mechanism 64 that moves latch bolt 54 when handle 52 is turned by a user. When an authorized user enters a correct passcode, presents a valid card (or key fob, etc.), or otherwise provides valid credentials to input device 60, controller 62 instructs motor 56 to move or otherwise allow latch bolt 54 to be retracted by the user. If invalid credentials are presented, controller 62 does not allow latch bolt 54 to be retracted, e.g., controller 62 controls motor 56 to remain in or move to a position blocking latch bolt 54. Energy storage device 58 provides stored electrical power to controller 62, motor 56, and any other electrically powered components of lock 28. In one embodiment, energy storage device 58 includes a battery. In another embodiment, energy storage device 58 includes a capacitor, such as an ultracapacitor (or supercapacitor), which stores energy in an electric field. The ultracapacitor may include a double-layer capacitor, a pseudocapacitor, and/or a hybrid capacitor having both double-layer capacitance and psuedocapacitance. In one embodiment, each electrode or plate of the ultracapacitor is carbon coated and immersed in an electrolyte. According to the preferred embodiment of the present disclosure, closure portion 40 of power coupling 36 is positioned above or below chassis 50, and door 24 includes an interior region sized to receive wires 44 extending from closure portion 40 to chassis 50. According to another embodiment, closure portion 40 is positioned within chassis 50.

As discussed above, power coupling 36 transmits power from power supply 42 to door lock 28. Typically, power supply 42 is an AC power supply and a transformer 66 is provided to convert AC power to DC power. This DC power is converted back to AC at an appropriate frequency by transmitter 68 of perimeter portion 38 and wirelessly transmitted by transmitter 68 to receiver 70 of door portion 40 of power coupling 36. Electrical conduit 46, such as a wire, transmits the power to controller 62, which directs this power to energy storage device 58 for charging or to the other electrically powered components, such as motor 56. Thus, when door 24 is closed, the power used by motor 56 may be supplied from power coupling 36 without first passing through energy storage device 58. However, if door is open 24 or power is not available through power coupling 36, energy storage device 58 may provide the necessary power to door lock 28.

The absence of power transfer or other communication through power coupling 36 may be used by controller 62 (or control station 48) as an indication that door 24 has been opened. If this condition is detected, controller 62 (or control station 48) may activate an alarm or take other actions. In addition to detecting the lack of power transfer, controller 62 (or control station 48) may be configured to determine if the format of an input transmitted by power coupling 36 matches a predetermined format. If the format does not match, controller 62 (or control station 48) may determine that an error has occurred. For example, control station 48 may provide an input signal at a steady (or changing) frequency, which controller 62 recognizes. If controller 62 does not recognize the frequency as a matching frequency, it may determine that an error has occurred and send out a predetermined output in response. The predetermined output may be an alarm. Unauthorized persons may attempt to fool controller 62 (or control station 48) into detecting door 24 being closed by providing an alternative perimeter coupling and moving it with door 24 as door 24 opens. However, unless the alternative perimeter coupling provides a frequency closely matching that normally provided by transmitter 68, receiver 70 will not detect the mismatched frequency so there is no signal sent to controller 62. Alternatively, receiver 70 detects the frequency, but controller 62 detects a mismatch in the received signal and generates an alarm. Thus, controller 62 (or control station 48) is a door position monitor that monitors power coupling 36 to determine the position of door 24. Similar controllers may be provided on the other electronic devices 10.

Control station 48 may also communicate with lock electronic devices 26, such as electronic lock 28, using power coupling 36. Transmitter 68 embeds data within the signals it sends to receiver 70. This data may include lock/unlock commands, software updates, updates for authorized credentials, passwords, lock down instructions, etc. Similarly, electronic lock 28 may communicate back to control station 48. According to this embodiment, both transmitter 68 and receiver 70 are transceivers that can send and receive information. The data sent from electronic lock 28 to control station 48 may include credential data, sensor data, access request histories and associated credential ID's, maintenance requests, etc. According to alternative embodiments, other communication means may be used such as infrared transceivers.

The entire disclosure of International Application Serial No. PCT/US13/37706, titled “Architectural Closure Powering Device,” filed Apr. 23, 2013, is expressly incorporated by reference herein.

Although the invention has been described in detail with reference to certain preferred embodiments, variations and modifications exist within the spirit and scope of the invention as described and defined in the following claims.

What is claimed is:

1. A closure position detector for use with an architectural opening having a perimeter and a closure having an outer perimeter and moveable between an open position and a closed position closing the opening, the closure position detector including:
an electronic device supportable by the closure and including a wireless power coupling configured to receive power wirelessly through the perimeter of the closure to power the electronic device; and
a closure position monitor monitoring the wireless power coupling to determine the position of the closure.

2. The closure position detector of claim 1, wherein the wireless power coupling is an inductive coupling.

3. The closure position detector of claim 1, wherein the electronic device controls operation of a latch bolt of a lock supported by the closure.

4. The closure position detector of claim 3, wherein the electronic device includes a motor providing mechanical power to control operation of the latch bolt.

5. The closure position detector of claim 1, wherein the closure position monitor is supportable by the closure.

6. The closure position detector of claim 1, wherein the closure position monitor is supportable away from the closure.

7. The closure position detector of claim 1, wherein the electronic device includes a motor positioned to move a component supported by the closure, and power from the wireless power coupling powers operation of the motor.

8. An architectural opening and closure system including:
an architectural opening having a perimeter;
a closure having an outer perimeter and being moveable between an open position and a closed position closing the architectural opening; and
a closure position detector including
an electronic device supported by the closure and including a wireless power coupling configured to receive power wirelessly through the perimeter of the architectural opening to power the electronic device and
a closure position monitor monitoring the wireless power coupling to determine the position of the closure.

9. The system of claim 8, wherein the wireless power coupling is an inductive coupling.

10. The system of claim 8, further comprising a lock having a latch bolt that extends between the closure and the perimeter of the architectural opening and the electronic device controls operation of a latch bolt.

11. The system of claim 10, wherein the electronic device includes a motor providing mechanical power to control operation of the latch bolt.

12. The system of claim 8, wherein the closure position monitor is supported by the closure.

13. The system of claim 8, wherein the closure position monitor is supported by the perimeter of the architectural opening.

14. The system of claim 8, wherein the electronic device includes a motor positioned to move a component supported by the closure, and power from the wireless power coupling powers operation of the motor.

15. A door system including:
a door having an outer perimeter and moveable between open and closed positions; and
an electronic device supported by the door and including
a chassis having a lower-most portion and an upper-most portion, and
an electronic assembly controlling operation of the door, the electronic assembly including a wireless power coupling positioned below the lower-most portion of the chassis or above the upper-most portion of the chassis and a powered portion positioned in the chassis and powered by power transmitted through the wireless power coupling.

16. The door system of claim 15, wherein the electronic device includes electrical conduit extending from the wireless powering coupling to transmit power from the wireless powering coupling and at least a portion of the electrical conduit is positioned outside of the chassis.

17. The door system of claim 16, wherein the door includes an interior region having a first portion sized to receive the chassis, a second portion sized to receive the wireless power coupling, and a third portion sized to receive the electrical conduit, and the third portion of the interior region is positioned vertically between the first and second portions of the interior regions.

18. An electronic closure device for use with an architectural opening having a perimeter and a closure having an outer perimeter, the closure being moveable between an open position and a closed position closing the opening, the electronic closure device supportable by the closure and including:
a wireless power coupling configured to receive power wirelessly through the outer perimeter of the closure to power the electronic closure device; and
a controller receiving input from the wireless power coupling providing power, the controller anticipating the format of the input and providing a predetermined output based on the format of the input.

19. The electronic closure device of claim 18, wherein the input from the wireless power coupling is at a predetermined frequency and the controller anticipates the predetermined frequency.

20. The electronic closure device of claim 18, wherein the predetermined output indicates that the closure is in the closed position if the anticipated format matches the input from the wireless power coupling.

21. The electronic closure device of claim 18, wherein the predetermined output indicates an error condition if the anticipated format does not match the input from the wireless power coupling.

22. The electronic closure device of claim 18, wherein the predetermined output indicates that the closure is in the open position if the anticipated format does not match the input from the wireless power coupling or insufficient input is received from the wireless power coupling.
